(19) United States
(12) Patent Application Publication
(10) Pub. No.: US 2003/0110701 A1
(43) Pub. Date: Jun. 19, 2003

(54) Window operators

(76) Inventor: Guy Simon Dawson, Wellington (NZ)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/319,055

(22) Filed: Dec. 13, 2002

(30) Foreign Application Priority Data
Dec. 14, 2001 (NZ) 515949

(51) Int. Cl. E05D 15/28

(52) U.S. Cl. 49/246

(57) ABSTRACT

A window operator for the opening and closing of a hinged window. The window operator has a rotatable lead screw 16 on which moves a slider 19. A driving element 18 is threaded on to the lead screw 16 and is coupled to the slider 19. A lost motion mechanism is operable upon the sliding movement of the slider being inhibited at final closing or initial opening of the window. The lost motion mechanism includes a tab 42 engaged in a helical slot 43. Movement of the tab in the helical slot causes an angular displacement of the driving element 18. A retention member 47 is moveable in response to the angular displacement and retains the slider 19 against movement while the driving element 18 continues to move along the lead screw. The tab 42 is thus moveable along slot 49 to operate a multipoint locking mechanism L.

### BACKGROUND TO THE INVENTION

This invention relates to improvements in window operators and more particularly a lost motion mechanism for operating a multi-point locking arrangement.

In our New Zealand patent specification 336579 there is disclosed a window operator for controlling movement of a window sash relative to a window frame. Conventionally a window sash is mounted in the window frame by a pair of hinges. Typically for a sash which can be moved between open and closed position by an operator, the hinges mount the sash in a casement configuration. With the window operator of NZ 336579, however, one of the hinges forms part of the operator itself. This results in not only a more compact arrangement but also does away with the need for separate mounting of the operator and hinge.

In a preferred form of the window operator as disclosed in NZ 336579 the operator is also able to automatically control a multi-point locking device. Thus, as the sash is moved into its closed position, continued operation of the operator enables the multi-point mechanism to operate and lock the window. Likewise at opening the initial operation of the operator releases the multi-point so that continued operation of the operator is able to move the sash to an open position.

### SUMMARY OF THE INVENTION

An object of the present invention is to provide a lost motion mechanism of simple construction yet able to provide an effective moving force to control a multi-point locking mechanism.

Broadly in one aspect of the invention there is provided a lost motion mechanism including a driving element coupled with a driven element, a displacement arrangement to cause an angular displacement of the driving element, a retention member moveable, in response to said angular displacement, to a retention position to retain said driven element against movement and a guide to guide movement of the driving element relative to said driven element, the driving element being coupled to an engagement element which is operatively engageable with a drive bar of a multi-point lock mechanism to controllably move said drive bar.

Preferably, the driving element is engageable with a lead screw and drives the driven element in response to rotation of the lead screw.

In a preferred form of the invention the displacement arrangement to angularly displace the driving element is a slot in the drive element, Preferably, the slot is helical.

The engagement element is preferably a projection which slidingly locates in said slot. The guide is preferably an elongate slot which extends in a direction parallel to the lead screw, said elongate slot extending from said helical slot.

### BRIEF DESCRIPTION OF THE DRAWINGS

In the following more detailed description of the invention according to one preferred embodiment reference will be made to the accompanying drawings in which:

FIG. 1 is a general perspective view of a window sash and window frame where the sash is mounted by and its movement controlled by a window operator, the window operator also able to control a multi-point locking arrangement,

FIG. 2 is a similar view but with the sash, window frame and sill removed to show the operator and multi-point locking arrangement,

FIG. 3 is a perspective view of the operator from the opposite direction as taken in FIG. 2 and with the window hinge in a closed position,

FIG. 4 is a perspective view of the lost motion mechanism formed by a slider, a drive nut engaged therewith and a lead screw with which the drive nut is engaged,

FIG. 5 is a further view of the lost motion mechanism after angular displacement of the drive nut from the position in FIG. 4 has occurred,

FIG. 6 is an elevation view of the arrangement shown in FIG. 5 but with the lead screw omitted, and

FIG. 7 is a perspective view of the drive nut.

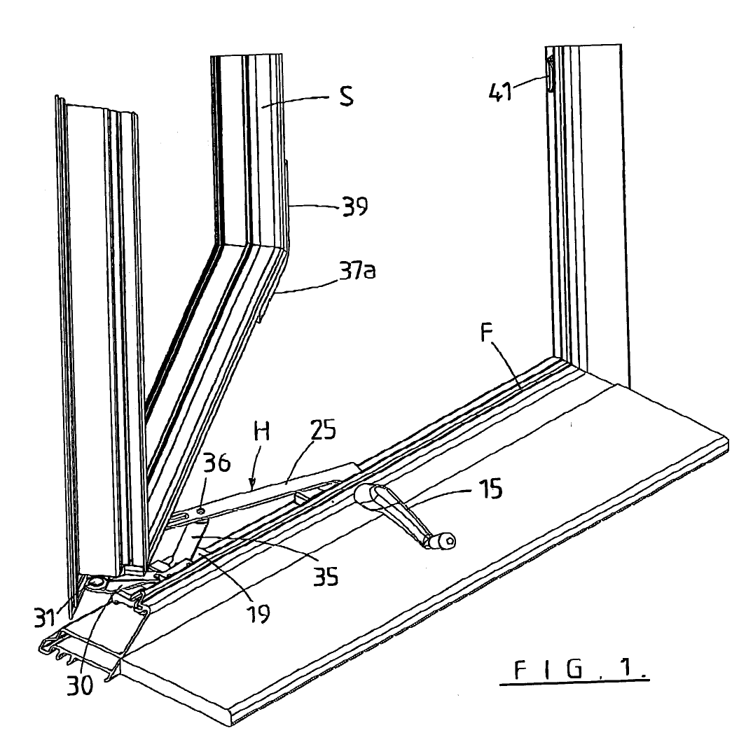

### DETAILED DESCRIPTION OF THE PREFERRED EMBODIMENTS OF THE INVENTION

The lost motion mechanism according to the invention has particular application for a window operator which is intended to also control a multi-point locking mechanism.

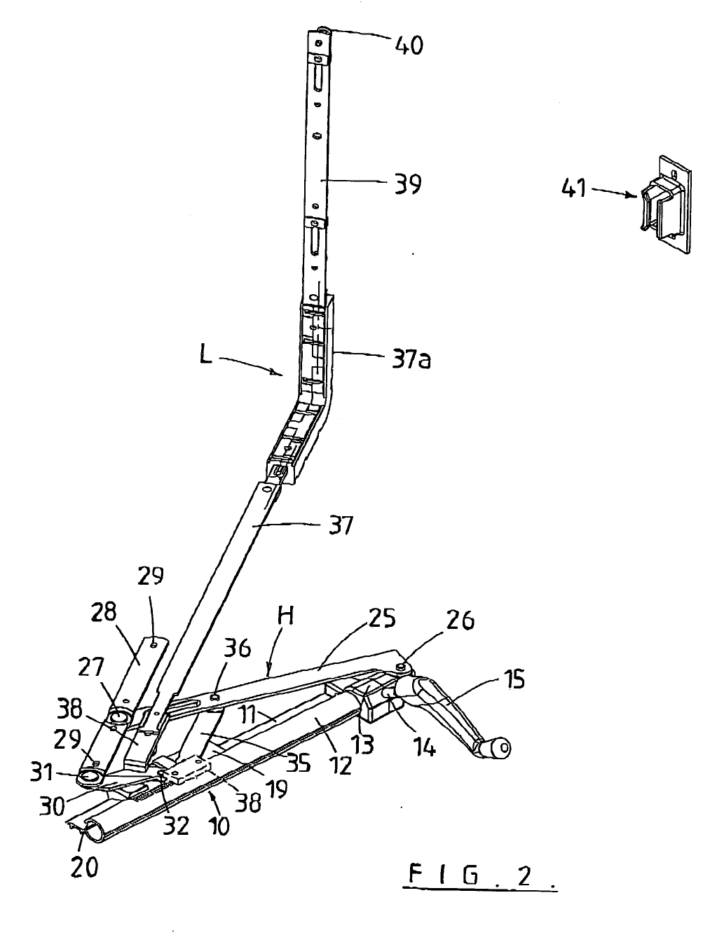

As more clearly shown in FIGS. 2 and 3 an operator incorporating the lost motion mechanism includes a frame plate 11 and elongate housing 12 which, in the preferred form of the invention, is of generally hollow circular cross-section. The housing 12 extends from a gearbox 13 which in the preferred form is situated at one end of the housing 12. A shaft 14 extends from the gearbox 13 and a handle 15 is mounted thereon.

A lead screw 16 is mounted by suitable bearings to be rotatable and extends along the interior of the housing 12. One end of the lead screw 16 is coupled into the gearbox 13. Accordingly rotation of handle 15 results in rotation of the lead screw 16.

Threaded on to the lead screw 16 is a drive nut 18. The drive nut 18 is engaged with a slider 19 this slider extending through an elongate slot 20 which extends for the length of the housing 12. The underside surface 21 of the slider 19 slidingly engages on the mounting plate 11. In the preferred form of the invention the distal edge 22 of the slider 19 is formed with a return 23 which engages about a longitudinal edge 24 of the mounting plate 11.

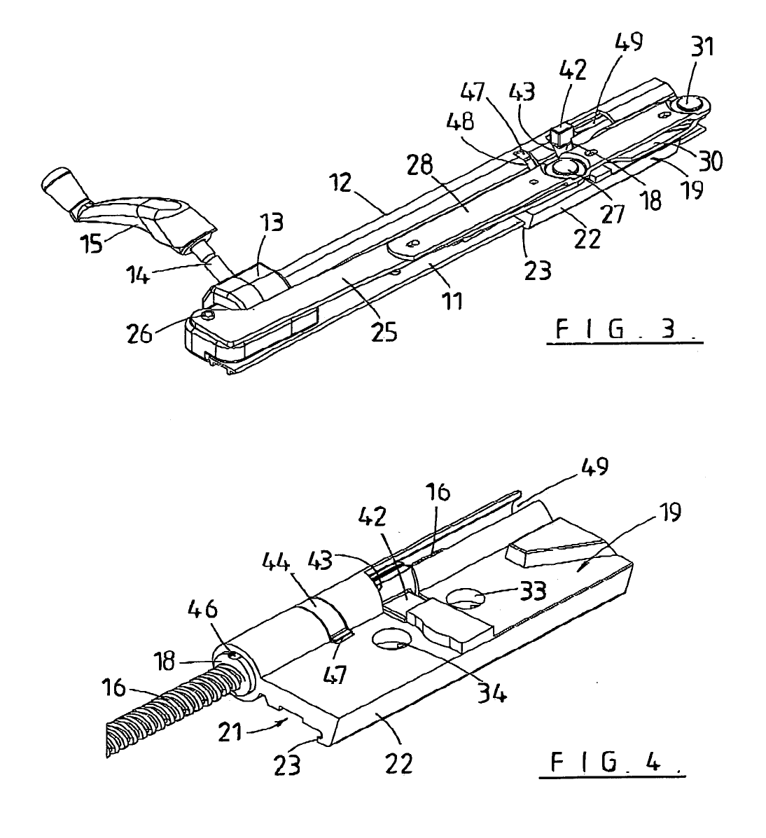

As can be seen in FIG. 4 the underside 21 of the slider 19 is configured so that a clearance is provided for the head of mechanical fasteners (not shown) used to mount the mounting plate 11 to the window frame section F.

As with the arrangement disclosed in NZ 336579 a window hinge H is mounted with and forms part of the operator 10. In the preferred form of the invention the window hinge H consists of a long arm 25 which is pivoted at 26 adjacent the gearbox 13. The other end of the long arm 25 is pivotally coupled by bearing 27 to a sash mounting plate 28. The sash mounting plate is formed with openings 29 whereby the sash S can be mounted to the hinge H.

It will be observed that pivot 26 is offset to a line through bearings 27 and 31 when the stay is in the closed position (see FIG. 3). This is achieved by a cranked end of long arm 25 locating in a rebated section of the gearbox housing. This is achievable because the movement of tab 42 (as will hereinafter become evident) is such that the necessary extent of movement of the tab to operate the multi-point is achieved in a compact arrangement thereby leaving sufficient length in the mounting plate 11 to accommodate the offset end of long arm 25.

A short arm 30 is pivotally coupled at one end by pivot bearing 31 to the sash mounting plate 28. The other end of the short arm 30 is pivoted at bearing 32 to the slider 19. As can be seen, for example in FIG. 2, an opening 33 is formed in the slider 19 to accommodate the pivot bearing 32. Likewise an opening 34 is provided in the slider 19 for a pivot bearing (not readily visible) for pivot mounting of a link arm 35.

The link arm 35 is pivoted at 36 to the long arm 25. Thus the long arm 25, short arm 32, sash mounting plate 28 and link arm 35 form the hinge B for mounting the sash 5 to the frame F. The driving force for opening and closing the sash is transmitted by the operator 10 to the sash S via short arm 30 and link arm 35 as the lead screw 16 is rotated to cause sliding movement of the slider 19 along the mounting plate 11.

Referring to FIG. 2 there is also shown a multi-point locking arrangement L which is, in use, mounted with the sash S. The multi-point locking arrangement L includes a drive bar 37 with a multi-point pickup 38 at one end thereof. The drive bar 37 is connected to a corner drive 37a which is in turn coupled to a lock bar 39. The lock bar 39 includes a plurality of pins or projections 40 though in the drawings only one is shown. Likewise an equal number of keepers 41 are mounted with the frame section F. Thus when the multi-point L is moved into a locking position the pins 40 locate within respective keepers 41 to lock the sash S against opening.

To more fully describe the preferred embodiment of the invention reference will now be made to the combination of window operator 10, hinge H and multi-point L when in use.

From the sash S being in the fully opened position relative to the frame F rotation of the handle 15 rotates the lead screw 16 by transmitting drive through bevel gears (not shown) in the gearbox 13. The lead screw 16 moves the slider 19 by acting on the drive nut 18 captured in the slider 19 (see FIG. 4).

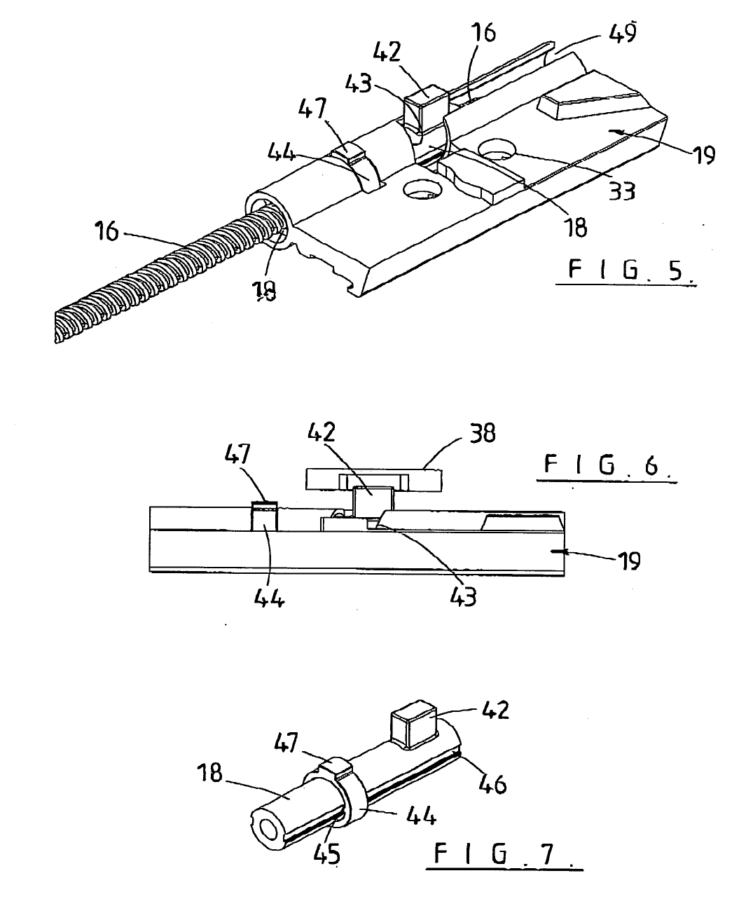

When the sash S has moved to its closed position there is a resistance to movement of the slider 19. Consequently continued rotation of the lead screw 16 forces a drive nut tab 42 to move along a helical slot 43 in the slider 19. The helical slot 43 provides the beginning of free motion between the drive nut 18 and the slider 19. The configuration of the slot causes the drive nut 18 to angularly displace and as a result drive nut tab 42 rotates upward to a position (see FIG. 5) where it engages with the multi-point pickup 38.

A lock ring 44 is slidingly engaged on the body of the lock nut 18 as shown in FIG. 7. The lock ring 44 has inwardly directed ribs 45 which slidingly engage in elongate longitudinally extending slots 46 in the body of the lock nut 18. The lock ring 44 furthermore, has a projection 47.

Because of the mechanical coupling of the lock ring 44 to the lock nut 18 rotation of the lock nut 18, which causes the lock ring tab 42 to move to its position where it engages with the multi-point pickup 38, also causes the lock ring 44 rotate. This moves the lock ring projection 47 from the position shown in FIG. 4 to the position shown in FIG. 5 where the projection 47 becomes engaged in a lock ring slot 48 in the housing 12. This engagement prevents the slider 19 from any further movement, this action taking place as the drive nut tab 42 disengages from the slider 19 to pickup the multi-point pickup 38.

Continued rotation of the lead screw 16,causes the lock nut 18 to continue to move. As a result the drive nut tab 42 moves along the longitudinal slot 49 in the slider 19. This continued movement of the drive nut tab 42 moves the lock bar 37 which via the corner drive 37a moves the lock bar 39 so that the pins 40 locate behind the flanges in the keeps 41. The window is, therefore, locked.

To open the window the handle 15 is rotated in the opposite direction. Because the slider 19 is locked against movement by projection 47 of the lock ring 44 in slot 48 the lead screw merely moves the drive nut 18. The drive nut tab 42 thus moves back along slot 49 drawing with it the drive bar 37 so as to unlock the multi-point L. When the lock nut tab 42 comes into contact with the edge of the helical slot 43 the continued rotation of the lead screw 16 causes the drive nut 18 to rotate by virtue of the drive nut tab 42 sliding along the helical slot 43. This in turn rotates the lock ring 44 which releases projection 47 from slot 48.

Once the drive nut 19 has moved to the position shown in FIG. 2 the drive nut 18 and slider 19 are re-coupled whereupon the slider 19 can move along housing 12 thereby applying a driving force via the hinge H to open the sash S.

The free motion mechanism according to the present invention is simple in construction. This is in part due to the use of a single slider. Not only in a minimum of parts employed in the mechanism (which is advantageous from the manufacturers point of view) but also the mechanism is easy to assemble. Furthermore, the mechanism, in use, results in a good length of movement of the driving element so that complete operation of the multi-point can be readily achieved.

A further advantage of the mechanism, when used as part of a window operator, is that the operation is relatively “light” which means that a high loading on the gearbox, operator handle hinge components etc does not occur at some point in the operation. For example, with known mechanisms a high loading can occur at initial opening of the sash.

The free motion mechanism therefore provides a simple yet effective means of providing movement to a multi-point locking arrangement. Consequently locking and unlocking of the multi-point can take place via the action of a window operator subsequent to the sash moving to the closed position and prior to the sash being able to move from said closed position.

What is claimed is:

1. A lost motion mechanism including a driving element coupled with a driven element, a displacement arrangement to cause an angular displacement of the driving element, a retention member moveable, in response to said angular displacement, to a retention position to retain said driven element against movement and a guide to guide movement of the driving element relative to said driven element, the driving element being coupled to an engagement element which is operatively engageable with a drive bar of a multi-point lock mechanism to controllably move said drive bar.

2. A lost motion mechanism as claimed in claim 1 wherein the driving element is engageable with a lead screw to, in use, drive the driven element in response to rotation of the lead screw.

3. A lost motion mechanism as claimed in claim 1 wherein the displacement arrangement to angularly displace the driving element is a slot in the drive element.

4. A lost motion mechanism as claimed in claim 3 wherein the slot is helical.

5. A lost motion mechanism as claimed in claim 4 wherein the engagement element is a projection which slidingly locates in said slot.

6. A lost motion mechanism as claimed in claim 5 wherein the guide is an elongate slot which extends in a direction parallel to the lead screw, said elongate slot extending from said helical slot.

7. A window operator including an elongate housing, a lead screw located within the housing and rotatable about a longitudinal axis, a slider and part of which is slidingly engaged with the elongate housing, a driving element threaded onto the lead screw and coupled to the slider to transfer rotation of the lead screw into a sliding movement of the slider, a lost motion mechanism operable upon the sliding movement of the slider being inhibited said lost motion mechanism including a displacement arrangement to cause an angular displacement of the driving element relative to the slide, a retention member moveable in response to said angular displacement to and from a retention position and a guide to guide movement of the driving element relative to the driven element when the retention member is in the retention position, the driving element having a coupling element which in use is operatively engageable with the drive bar of a multi-point lock mechanism.

8. A window operator as claimed in claim 7 wherein the driving element is engageable with a lead screw to, in use, drive the driven element in response to rotation of the lead screw.

9. A window operator as claimed in claim 8 wherein the displacement arrangement to angularly displace the driving element is a slot in the drive element.

10. A window operator as claimed in claim 9 wherein the slot is helical.

11. A window operator as claimed in claim 10 wherein the engagement element is a projection which slidingly locates in said slot.

12. A window operator as claimed in claim 11 wherein the guide is an elongate slot which extends in a direction parallel to the lead screw, said elongate slot extending from said helical slot.

13. A window operator as claimed in claim 12 wherein the driving element includes a threaded bore which threadingly engages on said lead screw, said nut including in an external surface thereof an elongate groove in which is slidingly engaged a rib of a locking collar, said retention member being formed by a projection from said collar.

14. A window operator as claimed in claim 13 wherein the engagement element is a lug which projects from said external surface of the nut.

15. A window operator as claimed in claim 14 wherein the nut is of circular cross section and is slidingly engaged in a circular bore which forms part of said slider.

16. A window operator as claimed in claim 15 wherein the retention member slidingly engages in a circumferential slot in the slider.

17. A window operator as claimed in claim 16 wherein the slider has pivotally coupled thereto at least one arm of a window hinge, said arm being pivotally coupled to a sash mounting plate.

18. A window operator as claimed in claim 17 wherein the sash mounting plate is pivotally coupled to a second arm which is longer than the first arm, said second arm being pivotally coupled to a mount located adjacent one end of the lead screw.

19. A window operator as claimed in claim 18 wherein the mount forms part of a gearbox housing from which extends the lead screw.

20. A window operator as claimed in claim 7 in combination with a multi-point lock mechanism, said multi-point lock mechanism including a drive bar which carries an engagement element with which said coupling element, in use, is operatively engageable to cause movement of the drive bar to occur and thereby operate the multi-point lock mechanism.
